(19) United States
(12) Patent Application Publication
(10) Pub. No.: US 2013/0122804 A1
(43) Pub. Date: May 16, 2013

(54) MOBILE DEVICE POWER MANAGEMENT

(71) Applicant: Siva G. Narendra, Portland, OR (US)

(72) Inventor: Siva G. Narendra, Portland, OR (US)

(21) Appl. No.: 13/295,902

(22) Filed: Nov. 14, 2011

(51) Int. Cl. H04B 5/00; H04W 88/02

(52) U.S. Cl. 455/41.1; 455/558

(57) ABSTRACT

Power categories are defined by power thresholds that correspond to an amount of power remaining in a mobile device's power source. Mobile device services, applications, or application components are binned into the power categories and disabled as the power sour is drained. A second power source may provide power to critical services after the first power source is drained.

### FIELD

The present invention relates generally to mobile devices, and more specifically to power management in mobile devices.

### BACKGROUND

Mobile devices typically include multiple device services that are powered by a single battery. When the battery is drained, all of the device services become unavailable at the same time.

### BRIEF DESCRIPTION OF THE DRAWINGS

FIG. 1 shows a mobile device with hardware control of power delivery to mobile device services;

FIG. 2 shows power categories defined by different power thresholds;

FIG. 3 shows a mobile device with software control of power delivery to mobile device services;

FIG. 4 shows a mobile device with multiple power sources;

FIG. 5 shows applications being binned into power categories;

FIG. 6 shows application components being binned into power categories;

FIGS. 7 and 8 show applications being installed on a mobile device in accordance with various embodiments of the present invention;

FIGS. 9-11 show mobile devices with multiple power sources in accordance with various embodiments of the present invention;

FIGS. 12 and 13 show mobile devices with memory cards that include secondary power sources in accordance with various embodiments of the present invention;

FIGS. 14 and 15 show example mobile devices in accordance with various embodiments of the present invention; and

FIG. 16 shows a flowchart of methods in accordance with various embodiments of the present invention.

### DESCRIPTION OF EMBODIMENTS

In the following detailed description, reference is made to the accompanying drawings that show, by way of illustration, various embodiments of an invention. These embodiments are described in sufficient detail to enable those skilled in the art to practice the invention. It is to be understood that the various embodiments of the invention, although different, are not necessarily mutually exclusive. For example, a particular feature, structure, or characteristic described in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

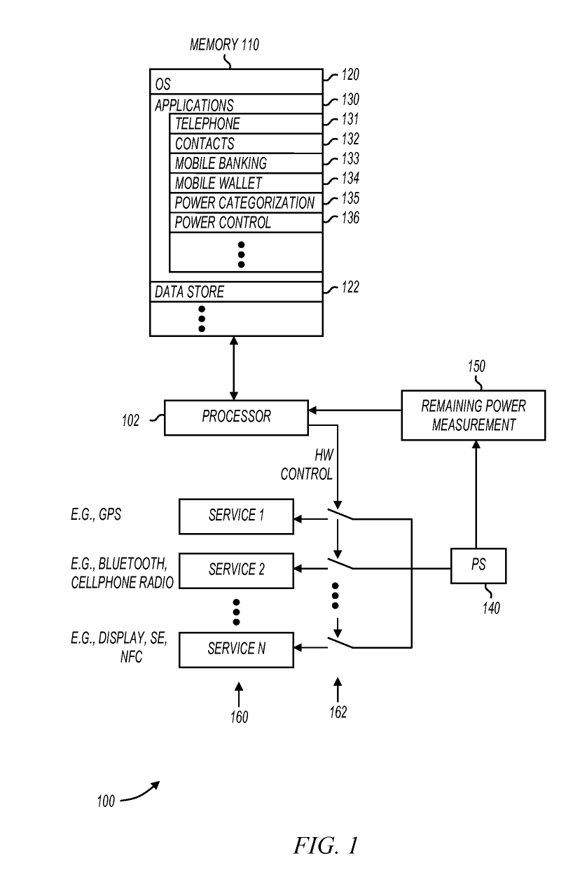

FIG. 1 shows a mobile device with hardware control of power delivery to mobile device services. Mobile device 100 includes processor 102, memory 110, power source 140, remaining power measurement component 150, and mobile device services 160. Mobile device 100 may be any type of mobile device that includes the components shown. For example, in some embodiments, mobile device 100 may be a cell phone, a smartphone, a tablet computer, a laptop computer, or the like.

Power source 140 may be any type of power source. For example, in some embodiments, power source 140 includes a battery. In other embodiments, power source 140 includes a jack to receive power from an external power source. Remaining power measurement component 150 includes circuitry that measures the amount of power remaining in power source 140. For example, in some embodiments, remaining power measurement component 150 includes a charge controller circuit that controls charging of a battery within power source 140, as well as measures and reports an amount of power remaining within power source 140. The amount of remaining power is reported to processor 102, which then may make use of that information in any manner.

Services 160 represent mobile device services within mobile device 100. For example, in some embodiments, services 160 may include a cell phone radio, a global positioning system (GPS) radio, a Bluetooth radio, a near field communication (NFC) radio, a smartcard secure element (SE), a display such as a touchscreen, and the like. Any number and/or type of services may be included within mobile device 100 without departing from the scope of the present invention.

Services 160 are coupled to receive power from power source 140. Further, processor 102 provides hardware control of power delivery to services 160 through switches 162. Switches 162 may be implemented in any manner. For example, in some embodiments, power supply lines to services 160 are physically switched with transistors, and in other embodiments, one or more of services 160 include internal hardware power control mechanisms that are controllable by processor 102.

In some embodiments, processor 102 controls power delivery to various services based on an amount of power remaining in power source 140. For example, processor 102 may progressively restrict access to services 160 as power source 140 is drained by progressively removing power to the various services.

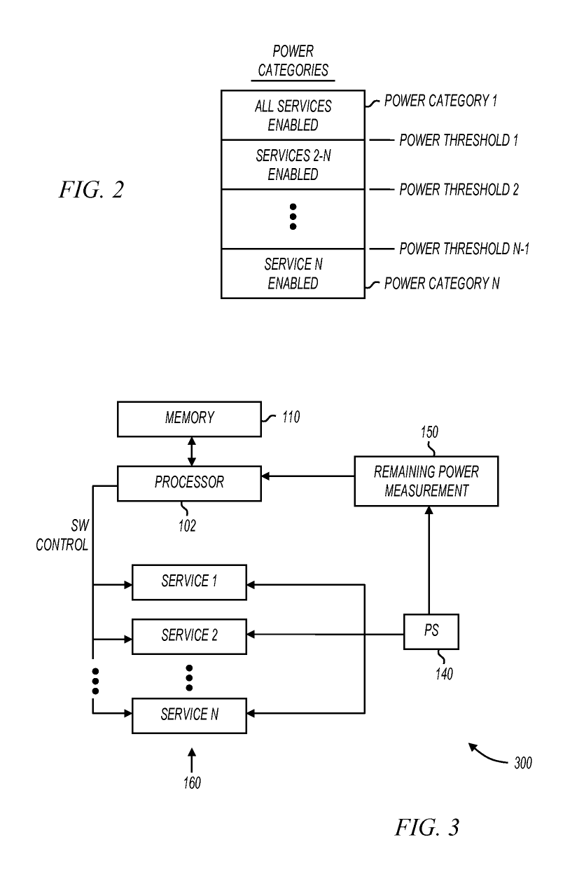

Referring now to FIG. 2, multiple power categories may be defined by power thresholds that correspond to an amount of power remaining in power source 140. As the remaining power decreases, then services 160 are progressively disabled. In the example of FIG. 2, all services are enabled when the remaining power is above power threshold 1 (operating in power category 1); services 2-N are enabled when the remaining power is above power threshold 2 (operating in power category 2); and only services N are available when the remaining power is below the last threshold, power threshold N-1 (operating in power category N).

Different services may be assigned to different power categories based on different factors. For example, services deemed critical for a particular function may be assigned to the last power category (power category N). The assignment may be static or may be dynamic. For example, in some embodiments, an NFC radio and SE may be assigned to power category N so as to provide mobile payment functionality as the last functions available as the power source is drained. Also for example, in some embodiments, a cell phone radio or Bluetooth radio may be assigned to power category N to provide communications functionality as the last functions available as the power source is drained.

Referring back to FIG. 1, memory 110 may include any type of memory device. For example, memory 110 may include volatile memory such as static random access memory (SRAM), or nonvolatile memory such as FLASH memory. Memory 110 is encoded with (or has stored therein) one or more software modules (or sets of instructions), that when accessed by processor 102, result in processor 102 performing various functions. In some embodiments, the software modules stored in memory 110 may include an operating system (OS) 120 and applications 130. Applications 130 may include any number or type of applications. Examples provided in FIG. 1 include a telephone application 131, a contacts application 132, a mobile banking application 133, a mobile wallet application 134, a power categorization application 135, and a power control application 136. Memory 110 may also include any amount of space dedicated to data storage 122.

Operating system 120 may be a mobile device operating system such as an operating system to control a mobile phone, smartphone, tablet computer, laptop computer, or the like. Telephone application 131 may be an application that controls a cell phone radio. Contacts application 132 includes software that organizes contact information. Contacts application 132 may communicate with telephone application 131 to facilitate phone calls to contacts.

Mobile banking application 133 may be a software application that communicates with a banking service to allow banking functions such as balance inquiries, funds transfers, bill payment and the like. Mobile banking application 133 may be a downloaded “thick” application, or may be a “thin” application that uses internet browser functionality.

Mobile wallet application 134 may be a software application that organizes payment instruments such as credit cards, debit cards, and pre-paid cards and identities such as a passport or a building access identity. In some embodiments, mobile wallet application 134 communicates with a smartcard secure element and/or an NFC radio within mobile device 100. For example, mobile wallet application 134 may store and access payment identities in a smartcard secure element and allow proximity payments using an NFC radio.

Power categorization application 135 provides categorization services that categorize services 160 into the power categories shown in FIG. 2. In some embodiments, power categorization application 135 includes a user interface component that allows a user to define the power thresholds, power categories, and which services 160 are in which power categories. In other embodiments, power categorization application 135 automatically or statically categorizes services 160 into power categories.

Power control application 136 controls power delivery to services 160 as power source 160 is drained. For example, power application 136 may cause processor 102 to progressively remove power from services 160 in accordance with the power categories as shown in FIG. 2.

Each of the above-identified applications correspond to a set of instructions for performing one or more functions described above. These applications (sets of instructions) need not be implemented as separate software programs, procedures or modules, and thus various subsets of these applications may be combined or otherwise re-arranged in various embodiments. For example, power categorization application 135 may be combined with power control application 136. Furthermore, memory 110 may store additional applications (e.g., video players, audio players, etc.) and data structures not described above.

It should be noted that device 100 is presented as an example of a mobile device, and that device 100 may have more or fewer components than shown, may combine two or more components, or may have a different configuration or arrangement of components. For example, mobile device 100 may include many more components such as sensors (optical, touch, proximity etc.), audio input devices, audio output devices, or any other components suitable for use in a mobile device.

Memory 110 represents a computer-readable medium capable of storing instructions, that when accessed by processor 102, result in the processor performing as described herein. For example, when processor 102 accesses instructions within power control application 136, processor 102 progressively removes power from services 160 as power source 140 is drained.

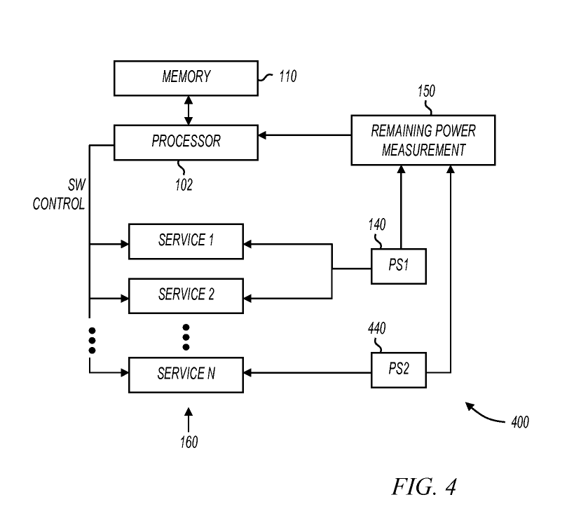

FIG. 3 shows a mobile device with software control of power delivery to mobile device services. Mobile device 300 includes processor 102, memory 110, services 160, power source 140, and remaining power measurement component 150, all of which are described above with reference to FIG. 1. Mobile device 300 differs from mobile device 100 (FIG. 1) in that mobile device 300 restricts access to services 160 through software control rather than hardware control. In some embodiments, access to entire services are restricted as in FIG. 1, and in other embodiments, access to services are restricted on an application by application basis. For example, data services may be denied to a video game, but allowed for a mobile payment application for a particular power category.

As an example, when the remaining power is below power threshold N-1 (FIG. 2), mobile wallet application 134 may be granted access to an NFC radio, whereas a tag reading application may be denied access to the NFC radio. In some embodiments, this may be implemented by refusing access to particular features of one or more application programming interfaces (API).

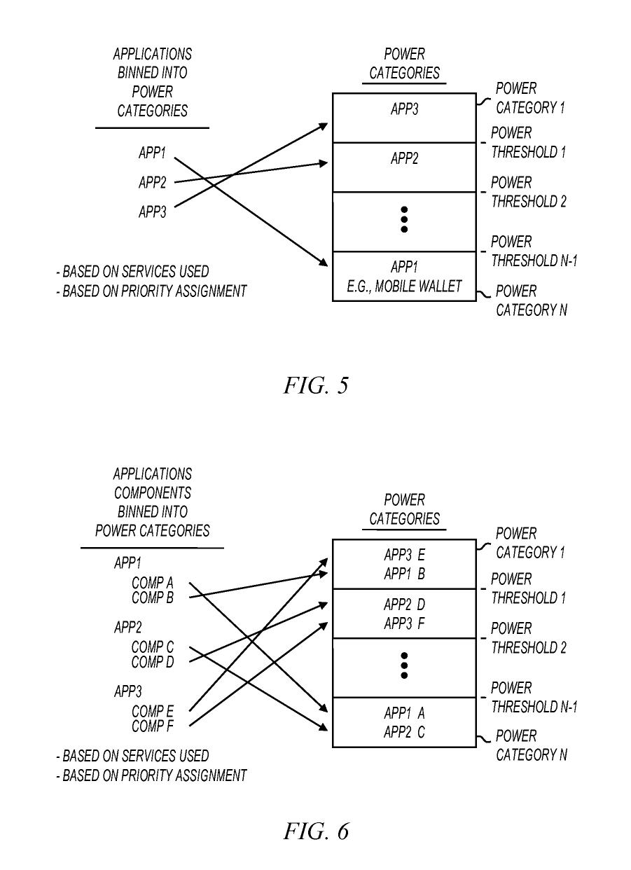

FIG. 4 shows a mobile device with multiple power sources. Mobile device 400 includes processor 102, memory 110, services 160, power source 140, and remaining power measurement component 150, all of which are described above with reference to FIG. 3. Mobile device 400 differs from mobile device 300 (FIG. 3) in that mobile device 400 includes a second power source 440. As shown in FIG. 4, a first subset of services 160 are powered by the first power source 140, and a second subset of services 160 are powered by the second power source 440. In some embodiments, power sources 140 and 440 are coupled together such that the first power source 140 is drained before the second power source. In these embodiments, services N are still available after the first power source is fully drained.

In some embodiments, multiple services that are used for a particular function are powered by the second power source. For example, an NFC radio and smartcard secure element may be powered by power source 440. In these embodiments, mobile payment functionality is available even after power source 140 is drained (and all other services are unavailable).

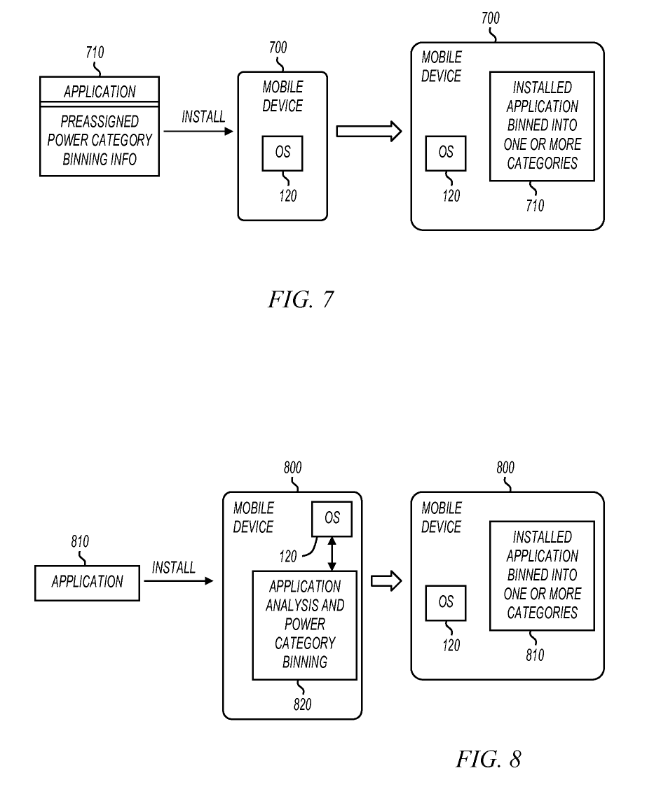

FIG. 5 shows applications being binned into power categories. The first, second, and third applications (APP1, APP2, APP3) represent applications stored in memory 110. For example, APP1 may be a mobile wallet application. Power categories are defined by power thresholds as described above with reference to

FIG. 2. As shown in FIG. 5, applications may be binned into power categories defined by the power thresholds. This is in contrast to FIG. 2, in which services are binned into categories.

In some embodiments, applications are binned into power categories based on services used. For example, applications that use NFC services may be binned into power category N, while applications that used Bluetooth services may be binned into power category 1. In other embodiments, applications are binned into power categories based on priority assignments regardless of services used. For example, low priority applications may be binned into power category 1 and high priority applications may be binned into power category N. As an example, a video player application may be binned into power category 1 and a mobile wallet may be binned into power category N.

As the power source is drained, applications are progressively disabled. For example, when in power category 1, all applications are enabled. When remaining power drops below power threshold 1, then APP3 is disabled. As the remaining power continues to decrease, applications are progressively disabled according to the binning shown in FIG. 5. In some embodiments, the applications are progressively disabled by power control application 136.

The binning shown in FIG. 5 may be static or may be dynamic. For example, in some embodiments, applications are statically assigned to power categories and cannot be changed. In other embodiments, applications may be assigned to power categories by power categorization application 135 when the applications are loaded. Further, applications may be assigned to power categories by power categorization component 135 in conjunction with user input.

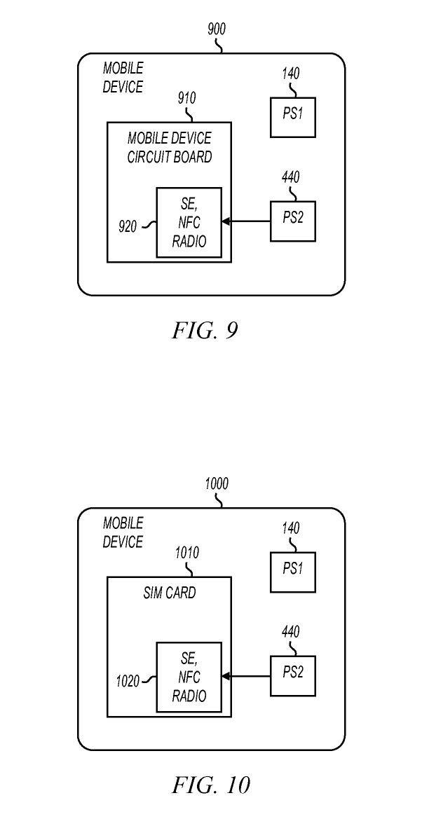

FIG. 6 shows application components being binned into power categories. The binning shown in FIG. 6 is similar to the binning shown in FIG. 5 except that in embodiments represented by FIG. 6, components of applications may be binned separately rather than entire applications being binned. For example, the first application APP1 may have a first component COMP A binned into power category N and a second component COMP B binned into power category 1. Components may be binned based on any criteria, including priority or services accessed. As an example, APP1 may be a mobile wallet application, APP1 COMP A may be a mobile payment component with a high priority, and APP1 COMP B may be a user interface component with a lower priority.

As shown in FIGS. 5 and 6, multiple power categories and corresponding power thresholds are defined that correspond to amounts of remaining power. Software applications are binned into the power categories such that functionality of the software applications diminishes when remaining available power drops below the power threshold corresponding to a power category into which the software application was binned. Binning may occur when loaded into the mobile device, may be pre-assigned, or may be modifiable with user input.

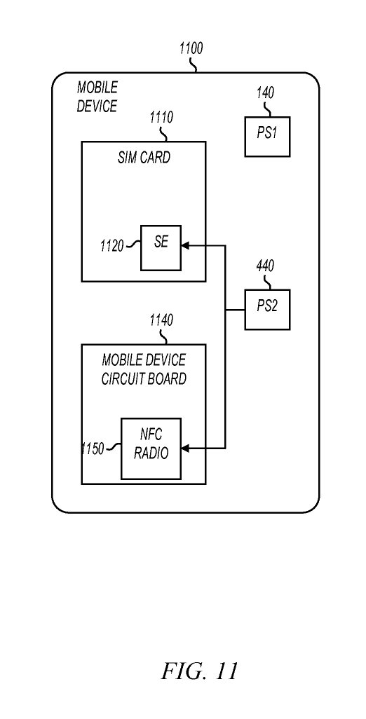

FIGS. 7 and 8 show applications being installed on a mobile device in accordance with various embodiments of the present invention. FIG. 7 shows application 710 being installed on mobile device 700. Application 710 may be any type of application that can be installed on a mobile device. Example applications are shown in FIG. 1. Other examples include video players, games, email clients, or any other type of application. Mobile device 700 may be any type of mobile device. For example, mobile device 700 may be a cell phone, smartphone, tablet computer, laptop computer, or the like. Further, mobile device 700 may restrict access to services by applications based on hardware control, software control, or any combination. Example mobile device architectures are shown in FIGS. 1 and 3.

As shown in FIG. 7, application 710 includes pre-assigned power category information. This information may specify categorization of the entire application (FIG. 5) or categorization of components within the application (FIG. 6). The pre-assigned power categorization information may originate from any source. For example, in some embodiments, a certification authority may analyze applications and assign power categories to applications or components. Also for example, in other embodiments, an application developer may make power category assignments. When application 710 is installed on mobile device 700, the application is binned into one or more power categories as shown in FIGS. 5 and 6.

FIG. 8 shows application 810 being installed on mobile device 800. Application 810 may be any type of application that can be installed on a mobile device. Example applications are shown in FIG. 1. Other examples include video players, games, email clients, or any other type of application. Mobile device 800 may be any type of mobile device. For example, mobile device 800 may be a cell phone, smartphone, tablet computer, laptop computer, or the like. Further, mobile device 800 may restrict access to services by applications based on hardware control, software control, or any combination. Example mobile device architectures are shown in FIGS. 1 and 3.

As shown in FIG. 8, application 810 does not include pre-assigned power category information. When application 810 is installed on mobile device 800, the application is analyzed and binned into one or more power categories by application analysis and power category binning component 820. Example binning results are shown in FIGS. 5 and 6. In some embodiments, the functions of application analysis and power category binning component 820 are performed when processor 102 executes instructions in power categorization application 135 (FIG. 1). The application may be analyzed based on any criteria and binned accordingly. For example, the application may be analyzed to determine which application programming interfaces (API) are accessed at runtime, and binning of applications and/or components may be performed based on API usage.

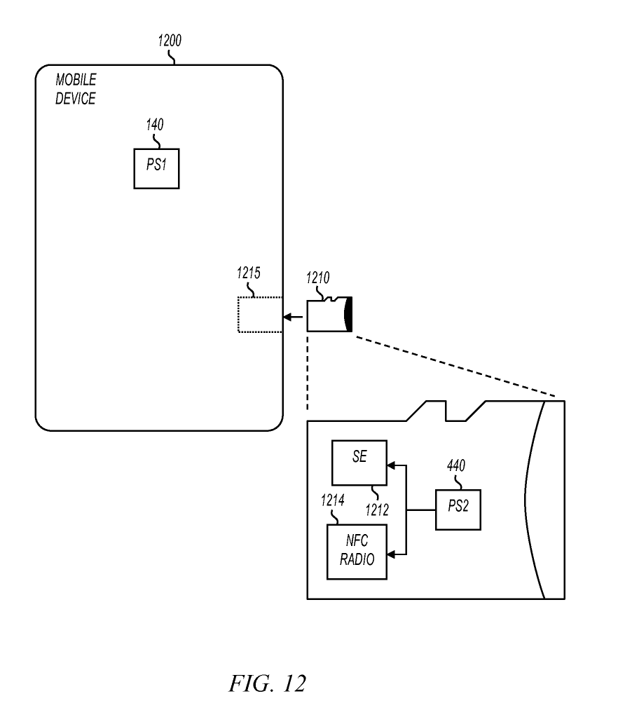

FIG. 9 shows a mobile device with multiple power sources in accordance with various embodiments of the present invention. Mobile device 900 includes circuit board 910 and power sources 140 and 440. Circuit board 910 includes circuits that provide one or more services. For example, circuit board 910 may include an NFC radio and/or a secure element. Also for example, circuit board 910 may include a processor, memory, or circuits that support other services. In some embodiments, circuit board 910 is a board that is fixed within mobile device 900 and that includes many components other than those shown.

As shown in FIG. 9, a subset of services are powered by the second power source 440. In some embodiments, the services powered by the second power source 440 are the services used for mobile payment. In the example of FIG. 9, an NFC radio and secure element are affixed to circuit board 910 and are powered by the second power source 440. In some embodiments, only an NFC radio is powered by the second power source 440, and in other embodiments, only a secure element is powered by the second power source 440.

In some embodiments, the secure element affixed to circuit board 910 may be a smart card controller that includes a secure element or functions as a secure element. Examples of smart card controllers are the “SmartMX” controllers sold by NXP Semiconductors N.V. of Eindhoven, The Netherlands. In some embodiments, the secure element has an ISO/IEC 7816 compatible interface that communicates with other components on circuit board 910 (e.g., processor 102), although this is not a limitation of the present invention. Further, in some embodiments, the secure element has an ISO/IEC 14443 contactless interface.

FIG. 10 shows a mobile device with multiple power sources in accordance with various embodiments of the present invention. Mobile device 1000 includes subscriber identity module (SIM) 1010 and power sources 140 and 440. SIM 1010 includes circuits that provide one or more services. For example, SIM 1010 may include an NFC radio and/or a secure element. Also for example, SIM 1010 may include other circuits that identify a user of mobile device 1000 to a mobile network operator. In some embodiments, SIM card 1010 is a removable card that is inserted into an add-on slot within mobile device 1000 and that includes many components other than those shown.

As shown in FIG. 10, a subset of services are powered by the second power source 440. In some embodiments, the services powered by the second power source 440 are the services used for mobile payment. In the example of FIG. 10, an NFC radio and secure element are affixed to SIM card 1010 and are powered by the second power source 440. In some embodiments, only an NFC radio is powered by the second power source 440, and in other embodiments, only a secure element is powered by the second power source 440.

FIG. 11 shows a mobile device with multiple power sources in accordance with various embodiments of the present invention. Mobile device 1100 includes subscriber identity module (SIM) 1110, circuit board 1140, and power sources 140 and 440. SIM 1110 and circuit board 1140 include circuits that provide one or more services. For example, SIM 1110 may include a secure element 1120, and circuit board 1140 may include an NFC radio 1150. In some embodiments, SIM 1010 may include other circuits that identify a user of mobile device 1000 to a mobile network operator. In some embodiments, SIM card 1110 is a removable card that is inserted into an add-on slot within mobile device 1100 and that includes many components other than those shown. Also for example, circuit board 1140 may include a processor, memory, or circuits that support other services. In some embodiments, circuit board 1140 is a board that is fixed within mobile device 1100 and that includes many components other than those shown.

As shown in FIG. 11, a subset of services are powered by the second power source 440. In some embodiments, the services powered by the second power source 440 are the services used for mobile payment. In the example of FIG. 11, an NFC radio on circuit board 1150 and a secure element affixed to SIM card 1110 are powered by the second power source 440. In some embodiments, only an NFC radio is powered by the second power source 440, and in other embodiments, only a secure element is powered by the second power source 440.

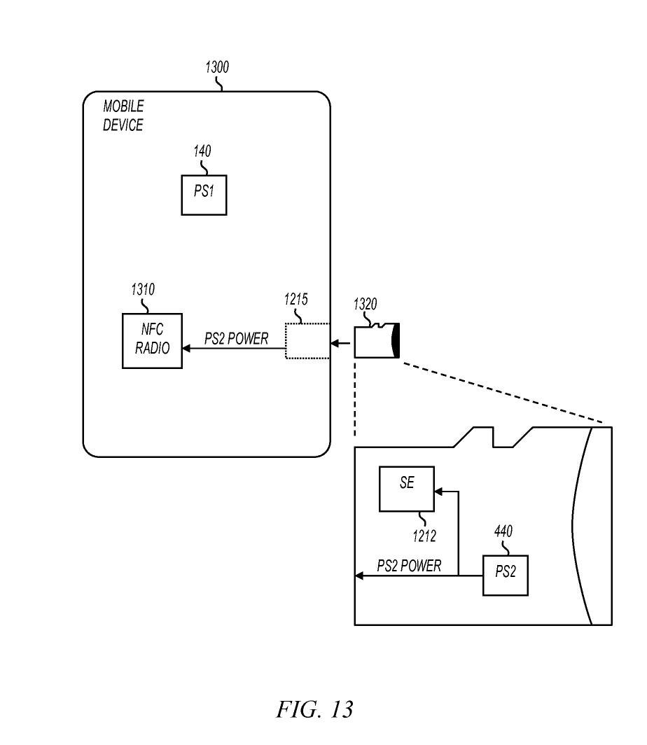

FIG. 12 shows a mobile device with a memory card that includes a secondary power source in accordance with various embodiments of the present invention. Mobile device 1200 includes power source 140 and add-on slot 1215. Add-on slot 1215 accepts memory card 1210, which is shown as a microSD memory card; however this is not a limitation of the present invention. Memory card 1210 includes secondary power source 440, NFC radio 1214, and secure element 1212. The combination of mobile device 1200 and memory card 1210 is an example of an electronic system that includes a mobile device and an add-on card that includes a second power source.

FIG. 13 shows a mobile device with a memory card that includes a secondary power sources in accordance with various embodiments of the present invention. Mobile device 1300 includes NFC radio 1310, power source 140 and add-on slot 1215. Add-on slot 1215 accepts memory card 1320, which is shown as a microSD memory card; however this is not a limitation of the present invention. Memory card 1320 includes secondary power source 440 and secure element 1212.

In some embodiments, power from secondary power source 440 is provided from memory card to 1320 to circuits within mobile device 1300. Any type of circuit within mobile device 1300 may be powered by secondary power source 440. In the example of FIG. 13, NFC radio 1310 is powered by secondary power source 440. The combination of mobile device 1300 and memory card 1320 is an example of an electronic system that includes a mobile device and an add-on card that includes a second power source.

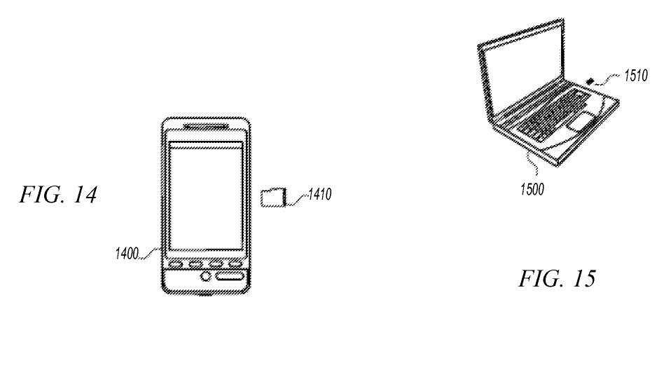

FIGS. 14 and 15 show example mobile devices in accordance with various embodiments of the present invention. FIG. 14 shows a mobile phone 1400. Mobile phone 1400 includes an add-on slot to accept memory card 1410. Memory card 1410 may be any memory card described herein, including memory card 1210 (FIG. 12) or memory card 1320 (FIG. 13). Further, mobile phone 1400 may be any mobile device described herein.

In some embodiments, mobile phone 1400 includes a secure element on a circuit board built in to the phone. For example, a smartcard secure element may be an integral part of the hardware of the phone either on the printed circuit board or inside the processor chip. In other embodiments, mobile phone 1400 may include a secure element within a subscriber identity module (SIM) card that is inserted in the phone. In still further embodiments, mobile phone 1400 may accept a memory card 1410 that includes a smartcard secure element.

In some embodiments, mobile phone 1400 includes a near field communications (NFC) radio built in to the phone. For example, an NFC radio and antenna may be an integral part of the hardware of the phone. In other embodiments, mobile phone 1400 may include an NFC radio within a subscriber identity module (SIM) card that is inserted in the phone. In still further embodiments, mobile phone 1400 may accept a memory card 1410 that includes an NFC radio with or without a built-in antenna. In some embodiments, the combination of mobile phone 1400 and memory card 1410 is an example of an electronic system that includes a mobile device and an add-on card that includes a second power source.

FIG. 15 shows laptop computer 1500 with add-on card 1510. Laptop computer 1500 is an example of a mobile device, such as the mobile devices shown in the previous figures. Add-on card 1510 may be a memory card as described above, or may be a universal serial bus (USB) dongle, or may be any other add-on card. Add-on card 1510 may include a secondary power source, an NFC radio, a secure element, or any other service. In some embodiments, the combination of laptop computer 1500 and add-on card 1510 is an example of an electronic system that includes a mobile device and an add-on card that includes a second power source.

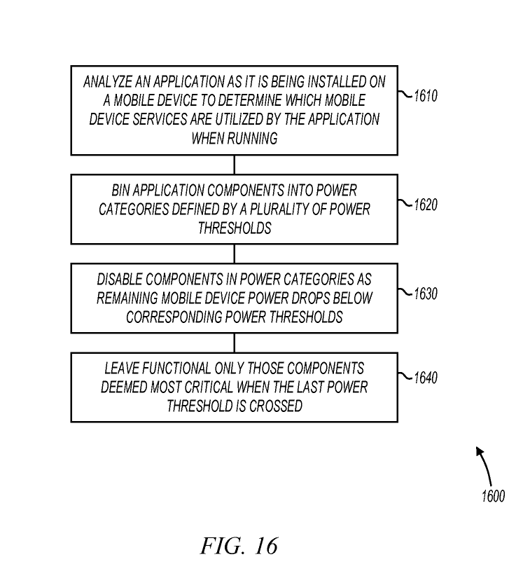

FIG. 16 shows a flowchart of methods in accordance with various embodiments of the present invention. In some embodiments, method 1600 may be performed by a mobile device such as any of mobile devices 100, 300, 400, 700, 800, 900, 1000, 1100, 1200, 1300, 1400, or 1500. Further, in some embodiments, method 1600 maybe be performed by a processor that is executing software such as power categorization application 135 and/or power control application 136. Method 1600 is not limited by the type of system or entity that performs the method. The various actions in method 1600 may be performed in the order presented, in a different order, or simultaneously. Further, in some embodiments, some actions listed in FIG. 16 are omitted from method 1600.

Method 1600 begins at 1610 in which an application is analyzed as it is being installed on a mobile device to determine which mobile device services are utilized by the application when running In some embodiments, the application is analyzed to determine which application programming interfaces (API) are accessed. In other embodiments, the application is analyzed by interpreting information supplied with the application. For example, binning information supplied with the application may be provided by a certification authority of an application developer. At 1620, application components are binned into power categories defined by a plurality of power thresholds.

At 1630, application components within power categories are disabled as remaining mobile device power drops below corresponding power thresholds. In some embodiments, this corresponds to measuring the power remaining in the mobile device's power source and progressively restricting access to mobile device services as power thresholds are crossed. At 1640, only those components deemed most critical are left functional when the last power threshold is crossed. This corresponds to power threshold N-1 being crossed and operating in power category N (FIG. 6). Any service or services may be deemed critical. For example, in some embodiments, services for mobile payment functionality may be deemed critical. Services for mobile payment functionality may include a smartcard secure element and/or a NFC radio.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A mobile device comprising:
a display;
a processor;
a main power source coupled to provide power to the display and the processor;
a smartcard secure element; and
a second power source coupled to provide power to the smartcard secure element.

2. The mobile device of claim 1 further comprising a removable card upon which the smartcard secure element is mounted.

3. The mobile device of claim 2 wherein the removable card comprises a subscriber identity module (SIM) card.

4. The mobile device of claim 2 wherein the removable card comprises a memory card.

5. The mobile device of claim 2 further comprising a near field communication (NFC) circuit that is not on the removable card.

6. The mobile device of claim 1 further comprising cellular telephone circuitry coupled to be powered by the main power source.

7. The mobile device of claim 1 further comprising a near field communication (NFC) circuit coupled to be powered by the second power source.

8. The mobile device of claim 7 further comprising a removable card upon which the smartcard secure element, the NFC circuit, and the second power source are mounted.

9. An electronic system comprising:
a mobile device that includes a main power source;
a second power source; and
a smartcard secure element coupled to receive power from the second power source.

10. The electronic system of claim 9 further comprising an add-on card, wherein the smartcard secure element resides on the add-on card.

11. The electronic system of claim 10 wherein the add-on card comprises a microSD memory card.

12. The electronic system of claim 10 wherein the add-on card comprises a subscriber identity module (SIM) card.

13. The electronic system of claim 9 further comprising a near field communication (NFC) circuit coupled to receive power from the second power source.

14. The electronic system of claim 13 further comprising an add-on card, wherein the smartcard secure element and the NFC circuit reside on the add-on card.

15. The electronic system of claim 9 wherein the smartcard secure element resides on the mobile device.

16. A mobile device comprising:
a first power source;
a plurality of services coupled to receive power from the first power source; and
a component to progressively restrict access to the plurality of services as the first power source is drained.

17. The mobile device of claim 16 wherein the component to progressively restrict access to the plurality of services comprises a hardware switch to progressively remove power from the plurality of services.

18. The mobile device of claim 16 wherein the component to progressively restrict access to the plurality of services comprises a software component that refuses access to particular features of application programming interfaces.

19. The mobile device of claim 16 wherein multiple power categories and corresponding power thresholds are defined that correspond to amounts of remaining power, and wherein software applications are binned into the power categories when loaded into the mobile device, such that functionality of the software applications diminishes when remaining available power drops below the power threshold corresponding to a power category into which the software application was binned.

20. The mobile device of claim 19 wherein the software applications are binned into power categories as a function of power usage.

21. The mobile device of claim 19 wherein software applications are analyzed at the time of loading to determine binning information.

22. The mobile device of claim 19 wherein software applications include pre-assigned binning information.

23. The mobile device of claim 19 wherein sub-portions of applications are binned in different categories.

24. The mobile device of claim 16 wherein the plurality of services comprises a cellular telephone radio, a smartcard secure element, and a near field communications (NFC) radio.

25. The mobile device of claim 16 further comprising a second power source that powers a subset of the plurality of services when the first power source is drained.

26. The mobile device of claim 25 wherein the subset of the plurality of services comprises a smartcard secure element and a near field communications (NFC) radio.

27. A method of installing applications on a mobile device, the method comprising:
analyzing the application to determine which mobile device services are utilized by the application when running; and
binning application components into power categories defined by a plurality of power thresholds, wherein binned application components in a particular power category are disabled when power available to the mobile device is below a corresponding power threshold.

28. The method of claim 27 wherein analyzing comprises determining which application programming interfaces are used by the applications.

29. The method of claim 27 wherein analyzing comprises interpreting information supplied with the applications.

30. The method of claim 29 wherein the information supplied with the applications is provided by an application developer.

31. The method of claim 29 wherein the information supplied with the application is provided by a certification authority.

32. A method comprising:
measuring power remaining in a mobile device's power source;
progressively restricting access to mobile device services as power thresholds are crossed; and
when a last threshold is crossed, restricting access to all services except those deemed necessary for mobile payment functionality.

33. The method of claim 32 wherein the services deemed necessary for mobile payment functionality include a smartcard secure element.

34. The method of claim 32 wherein the services deemed necessary for mobile payment functionality include a near field communications (NFC) radio.
